(19) United States
(12) Patent Application Publication
(10) Pub. No.: US 2014/0293247 A1
(43) Pub. Date: Oct. 2, 2014

(54) PROJECTION DISPLAY APPARATUS

(71) Applicant: PANASONIC CORPORATION, OSAKA (JP)

(72) Inventors: Takaaki ABE, Osaka (JP); Ken MASHITANI, Osaka (JP); Kazuma TANI, Osaka (JP); Masutaka INOUE, Osaka (JP); Nobuyuki KONDO, Osaka (JP)

(73) Assignee: PANASONIC CORPORATION, OSAKA (JP)

(21) Appl. No.: 14/224,898

(22) Filed: Mar. 25, 2014

(30) Foreign Application Priority Data
Mar. 27, 2013 (JP) 2013-065842
Apr. 4, 2013 (JP) 2013-078286
Mar. 24, 2014 (JP) 2014-060291

(51) Int. Cl. G03B 21/14; H04N 5/74

(52) U.S. Cl. CPC G03B 21/142; H04N 5/7458
USPC 353/101

(57) ABSTRACT

A projection display apparatus includes an optical system configured to project an image, an optical path changing unit configured to change an optical path of the image to change projected positions, on a projection plane, of pixels composing the image, a driver configured to shift the optical path changing unit, and a drive controller configured to control the driver. The drive controller controls the driver with a first constant voltage in a first constant voltage section, with a second constant voltage larger than the first constant voltage in a second constant voltage section, and with a first transition voltage continuously changing from the first constant voltage to the second constant voltage in a first transition section between the first constant voltage section and the second constant voltage section. The first transition voltage is a voltage that a waveform obtained by differentiating the first transition voltage is a continuous waveform.

### BACKGROUND

1. Technical Field

The present disclosure relates to a projection display apparatus capable of projecting an image by shifting an optical path of a projection light in a predetermined cycle.

2. Related Art

There is hitherto known a projection display apparatus which includes an optical path changing unit disposed between a back lens group and a front lens group, and shifts an optical path of a projection light in a vertical direction to an optical axis with the optical path changing unit (e.g., Unexamined Japanese Patent Publication No. 2005-227334).

By shifting the optical path of a projection light in the vertical direction to the optical axis, this projection display apparatus can present an image with higher resolution than resolution of an image displayed by a light bulb, without deterioration in image quality.

### SUMMARY

In such a projection display apparatus, the optical path changing unit is mechanically driven, and can thus generate drive sound which may be recognized as noise for a user. For this reason, the optical path changing unit is desirably driven with small noise.

An object of the present disclosure is to provide a projection display apparatus which can project an image with high resolution and can suppresses noise.

A projection display apparatus of the present disclosure includes a display unit configured to display an image, an optical system configured to project the image displayed by the display unit on a projection plane, an optical path changing unit configured to change an optical path of the image to change projected positions, on the projection plane, of at least part of pixels composing the image displayed by the display unit, the optical path changing unit disposed in a space between the display unit and the projection plane, a driver configured to shift the optical path changing unit, and a drive controller configured to control the driver. The drive controller controls the driver with a first constant voltage in a first constant voltage section, controls the driver with a second constant voltage that is larger than the first constant voltage in a second constant voltage section, and controls the driver with a first transition voltage that continuously changes from the first constant voltage to the second constant voltage in a first transition section between the first constant voltage section and the second constant voltage section. The first transition voltage is a voltage that a waveform obtained by differentiating the first transition voltage is a continuous waveform.

According to the present disclosure, in a projection display apparatus capable of projecting an image with high resolution, abrupt shift of the optical path changing unit is suppressed, thereby to allow suppression of noise caused by drive of the optical path changing unit.

### BRIEF DESCRIPTION OF DRAWINGS

FIG. 1 is a perspective view showing an external appearance of a projector according to the present disclosure;

FIG. 2 is a diagram showing an optical configuration of the projector according to the present disclosure;

FIG. 3 is a diagram showing an optical system provided between a projection optical system and a prism in a projector according to a first embodiment;

FIG. 4 is a diagram showing a configuration of an image output system in the projector according to the present disclosure;

FIG. 5 is a diagram showing an example of a base image that is inputted into the projector according to the present disclosure;

FIG. 6 is a diagram for explaining output of a sub-frame by the projector in the first embodiment;

FIGS. 7A and 7B are diagrams for explaining drive of a DMD (display device) and a piezo-electric device in the first embodiment;

FIGS. 8A and 8B are diagrams for explaining a drive waveform of the piezo-electric device in the first embodiment;

FIGS. 9A and 9B are diagrams for explaining a reason why drive waveforms of the piezo-electric device are made asymmetrical;

FIG. 10 is a diagram showing an optical system provided between a projection optical system and a prism in a projector according to a second embodiment;

FIG. 11 is a diagram showing a drive mechanism of the optical system provided between the projection optical system and the prism in the projector according to the second embodiment;

FIGS. 12A and 12B are diagrams for explaining a change in optical path by the optical system provided between the projection lens and the prism in the projector according to the second embodiment;

FIG. 13 is a diagram for explaining output of a sub-frame by the projector in the second embodiment;

FIG. 14 is a diagram for explaining drive of a DMD (display device) and a piezo-electric device in the second embodiment;

FIGS. 15A to 15D are diagrams explaining a waveform of a drive voltage of a piezo-electric device, and the like, in the case of switching from a normal mode to a high resolution mode in a third embodiment;

FIGS. 16A to 16D are diagrams explaining a waveform of a drive voltage of the piezo-electric device, and the like, in the case of switching from the high resolution mode to the normal mode in the third embodiment;

FIG. 17 is a diagram showing a configuration of an image output system in the projector according to a fourth embodiment;

FIG. 18 is a diagram explaining output of a sub-frame by the projector in the fourth embodiment;

FIGS. 19A to 19D are diagrams explaining a waveform of a drive voltage of a piezo-electric device, and the like, in the case of switching from the normal mode to the high resolution mode in the fourth embodiment; and

FIGS. 20A to 20D are diagrams explaining a waveform of a drive voltage of the piezo-electric device, and the like, in the case of switching from the high resolution mode to the normal mode in the fourth embodiment.

### DETAILED DESCRIPTION OF PREFERRED EMBODIMENTS

Hereinafter, embodiments will be described in detail with appropriate reference to the drawings. However, a description more detailed than necessary may be omitted. For example, a detailed description of a well-known matter or a repeated description of substantially the same configuration may be omitted. This is for the purpose of avoiding the following descriptions becoming unnecessarily redundant so as to facilitate understanding of the skilled person in the art.

In addition, the applicant provides the attached drawings and the following descriptions in order for the skilled person in the art to sufficiently understand the present disclosure, and do not intend to restrict by means of those the subjects recited in the claims.

### 1. First Embodiment

### 1-1. Outline

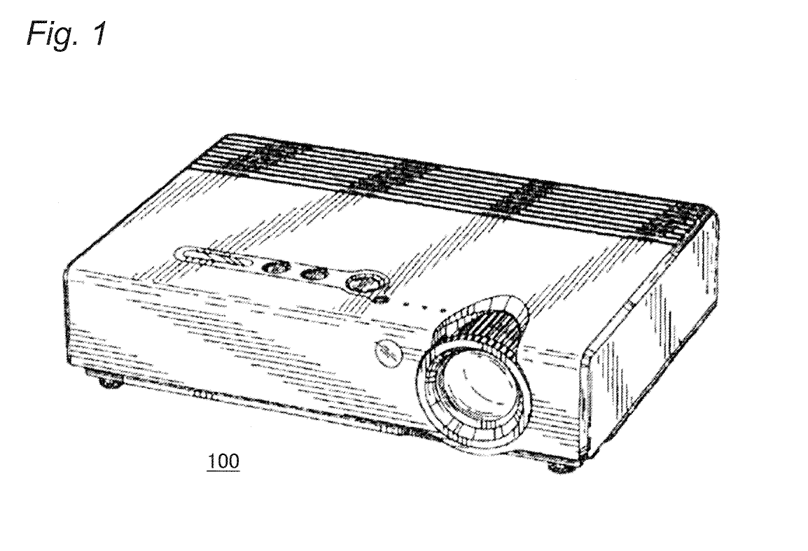

A outline of a projector 100 is described below with reference to FIG. 1. FIG. 1 is a perspective view showing an external appearance of the projector 100. The projector 100 is provided with a light source device, a digital mirror device (hereinafter referred to as “DMD”), and a projection optical system. The projector 100 generates an image by reflecting a light emitted from the light source device, with the DMD and projects the generated image on a screen (projection plane) through the projection optical system. The projector 100 has, as image projection mode, a normal mode, and a high resolution mode for projecting an image with higher resolution than in the normal mode.

The projector 100 is provided with an optical device (optical path changing unit) that can be shifted (moved) within a plane vertical to an optical axis of the projection optical system. In the normal mode, the projector 100 projects an image without moving the optical device. In the high resolution mode, the projector 100 shifts (moves) the optical device in a predetermined cycle and projects an image (sub-frame image) in synchronization therewith. That is, in the high resolution mode, moving the optical device (vibrated) within the plane vertical to the optical axis of the projection optical system in the predetermined cycle causes projected positions, on the screen, of pixels composing the image generated by the DMD (display device) to be shifted with a pitch not larger than a pixel pitch. Accordingly, the projector 100 can project an image with high resolution.

### 1-2. Configuration

### 1-2-1. Entire Configuration

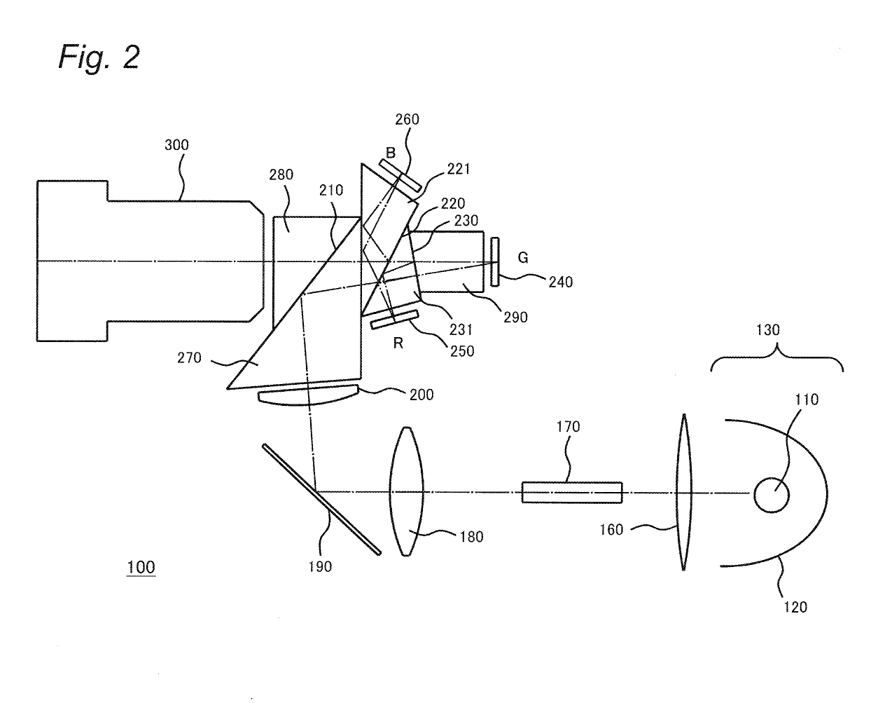

The entire configuration of the projector 100 is described below with reference to FIG. 2. FIG. 2 is a diagram showing the configuration of the projector 100. The projector 100 has a luminous tube 110 that emits light. Light emitted from the luminous tube 110 enters a prism 270 through a variety of optical systems and is divided into red light, green light and blue light in the prism 270. The respective divided light is incident on DMDs 240, 250, 260 as display devices provided for the respective green, red and blue light. The light reflected on each of the DMDs 240, 250, 260 is synthesized to generate an image. The generated image is projected on a screen through a projection optical system 300. Each of constitutional elements of the projector 100 will be specifically described below.

A light source 130 includes the luminous tube 110 and a reflector 120. The luminous tube 110 emits a light flux including red light, green light and blue light with different wavelength ranges. The luminous tube 110 is realized by an ultra-high pressure mercury lamp or a metal halide lamp, for example. The reflector 120 reflects the light flux emitted from the luminous tube 110 disposed in one focus position to guide the reflected light to collect the reflected light at another focus position.

The lighting optical system includes a lens 160, a rod 170, a lens 180 and a mirror 190. The lighting optical system guides the light flux emitted from the light source 130 to the DMDs 240, 250, 260. The rod 170 is a columnar glass member that totally reflects light inside thereof. The light flux emitted from the light source 130 is reflected inside the rod 170 more than once. This makes a light intensity distribution on the light-emitting surface of the rod 170 subsequently uniform.

The lens 180 is a relay lens that forms, on each of the DMDs 240, 250, 260, an image of the light flux on the light-emitting surface of the rod 170. The mirror 190 reflects the light flux having passed through the lens 180. The reflected light flux is incident on a field lens 200. The field lens 200 collects the incident light in a substantially parallel manner. The reflected light flux having passed through the field lens 200 is incident on a total reflection prism.

The total reflection prism is composed of a prism 270 and a prism 280. A thin air layer 210 exists between adjacent surfaces of the prism 270 and the prism 280. The air layer 210 totally reflects the light flux incident at an angle not smaller than a critical angle. The totally reflected light flux is incident on a color prism.

The color prism is composed of a prism 221, a prism 231 and a prism 290. A dichroic film 220 that reflects blue light is provided between the adjacent surfaces of the prism 221 and the prism 231. Further, a dichroic film 230 that reflects red light is provided between the adjacent surfaces of the prism 231 and the prism 290.

Each of the DMD 240, the DMD 250 and the DMD 260 has 1920×1080 micromirrors. Each of the DMD 240, the DMD 250 and the DMD 260 changes an orientation of each micromirror in accordance with an image signal so that the light incident thereon is divided into a light incident on the projection optical system 300 and a light to be reflected outside an effective range of the projection optical system 300. Green (G) light enters the DMD 240. Red (R) light enters the DMD 250. Blue (B) light enters the DMD 260. light fluxes incident on the projection optical system 300 out of the light fluxes reflected on the DMD 240, the DMD 250 and the DMD 260 are synthesized by the color prism. The synthesized light flux enters the total reflection prism. The light flux incident on the total reflection prism enters the air layer 210 at an angle not larger than the critical angle, passing through the air layer 210, and enters the projection optical system 300.

The projection optical system 300 is an optical system for expanding the incident light flux. The projection optical system 300 includes a focus lens and a zoom lens.

### 1-2-2. Configuration of Optical System Between Prism and Projection Lens

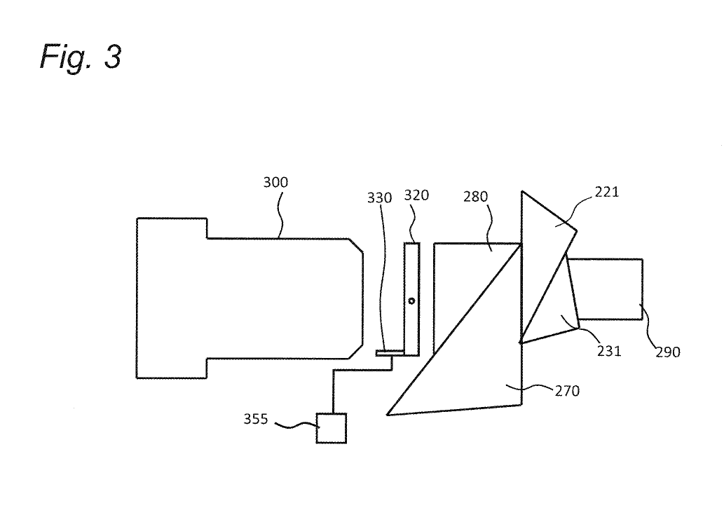

Next, using FIG. 3, there will be described a configuration between the projection optical system 300 and a prism block composed of the total reflection prisms (270, 280) and the color prisms (221, 231, 290). FIG. 3 is a diagram for explaining outline of the optical system provided between the projection optical system and the prism block.

Glass 320 and a piezo-electric device 330 are disposed between the projection optical system 300 and the prism 280. The piezo-electric device 330 is connected with a signal generator 355. Upon application of a voltage from the signal generator 355, the piezo-electric device 330 extends and comes into contact with the glass 320. The glass 320, with which the piezo-electric device 330 has come into contact, changes a posture to change an angle of the light flux incident on the glass 320 from the prism 280 changes. This results in a change in light traveling direction and a change in positions of pixels of the projected image. Recovery of the changed posture of the glass 320 is achieved by a spring (not shown) provided in the vicinity of the piezo-electric device 330. Light flux incident on the glass 320 in the recovered posture again transmits in the same direction as initial. The above function shifts the positions on the projection plane of the pixels composing the image which is displayed through the projection optical system 300.

### 1-3. Image Output Operation

### 1-3-1. Configuration of Image Output System

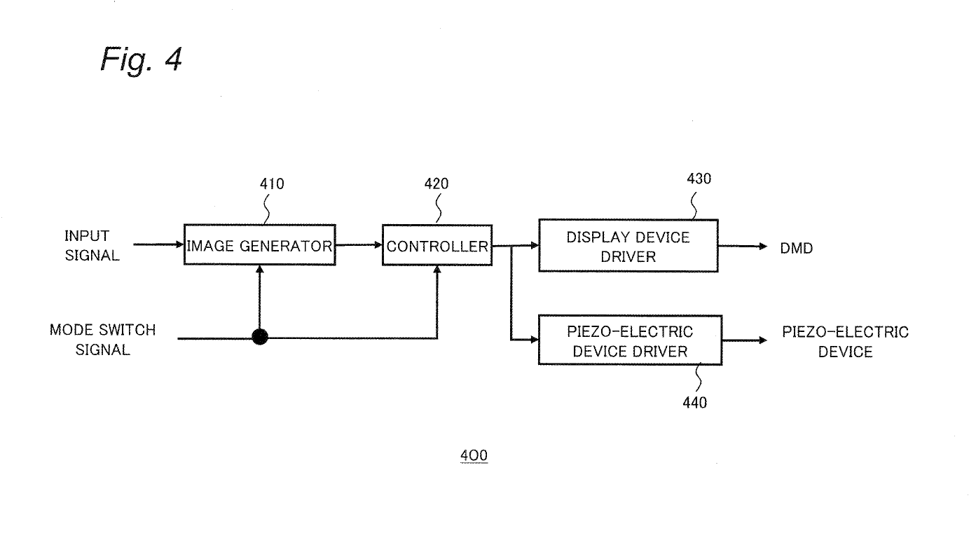

With reference to FIG. 4, a configuration of an image output system (one example of a drive controller) that generates signals for driving the DMDs 240 to 260 and the piezo-electric device 330 in the projector 100. An image output system 400 includes an image generator 410, a controller 420, a display device driver 430 and a piezo-electric device driver 440.

The image generator 410 generates two sub-frame signals corresponding to shift of projected positions by the glass 320 and the piezo-electric device 330, for each frame of an inputted image signal.

A mode switch signal is a signal for switching a projection mode to either one of the normal mode and the high resolution mode, and is generated inside the projector 100. The mode is switched by user setting, or is automatically switched based on resolution of the inputted image signal. It is to be noted that the number of pixels of the sub-frame signal is the same as the number of corresponding pixels of each DMDs 240, 250, and 260.

The controller 420 generates a synchronous signal for the display device driver 430 and the piezo-electric device driver 440 from the two sub-frame signals generated in the image generator 410. The controller 420 generates a synchronous signal by adding an identification signal that indicates which one of the two sub-frames to a synchronous signal that indicates timing for outputting a sub-frame. The synchronous signal distinguishes the sub-frame between a first sub-frame and a second sub-frame with different shapes of pulses that indicate the start of the sub-frames. The shape of this synchronous signal is not necessarily restricted to such a shape. For example, the first sub-frame and the second sub-frame may be distinguished by the synchronous signal having one shape of a High voltage state with respect to one of the sub-frames and the other shape of a Low voltage state with respect to the other.

The display device driver 430 drives the DMDs 240 to 260 based on the synchronous signal from the controller 420. Specifically, the display device driver 430 generates a signal (hereinafter referred to as “DMD drive signal”) for driving the DMDs 240 to 260 so that two sub-frames generated in the image generator 410 are displayed in one frame period. That is, the display device driver 430 generates the DMD drive signal so that the two sub-frame signals generated in the image generator 410 are outputted at twice a faster rate than an output frame rate.

The piezo-electric device driver 440 drives the piezo-electric device based on the synchronous signal from the controller 420. Specifically, the piezo-electric device driver 440 generates a drive signal (hereinafter referred to as “piezo-electric device drive signal) of the piezo-electric device 330 for driving the piezo-electric device 330 in synchronization with the display device driver 430 to shift projected positions of pixels.

### 1-3-2. Output Operation for Double Resolution Image

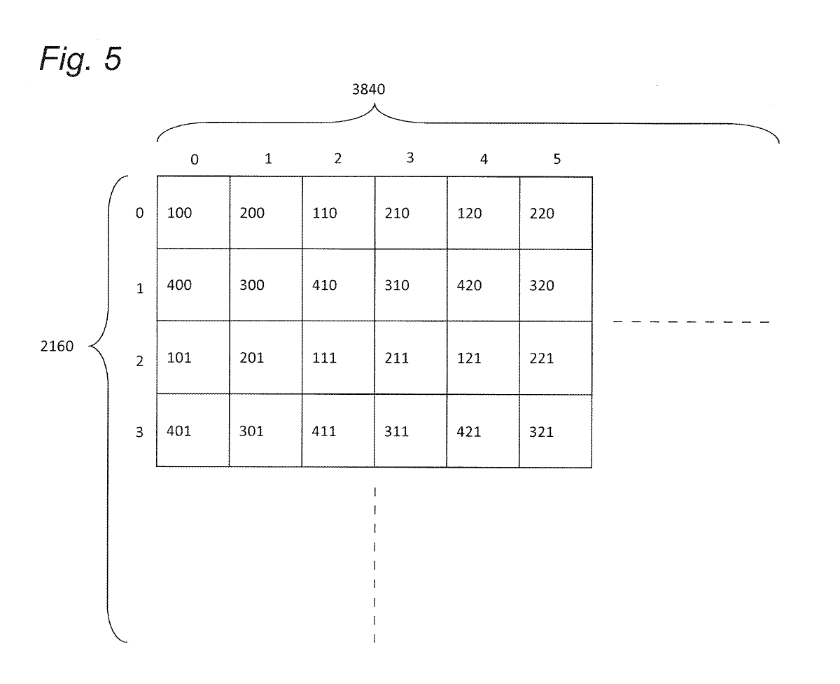

With reference to FIGS. 5 to 7, an example of a specific operation of the image output system 400 in the high resolution mode is described below. In the projector 100, each of the DMDs 240, 250, 260 can output an image with 1920 (horizontal)×1080 (vertical) pixels, respectively. Further, drive of the glass 320 and the piezo-electric device 330 causes the projected position to be shifted (moved) just by a half pixel in both the horizontal direction and the vertical direction.

FIG. 5 is a base image signal to be inputted into the image output system 400 of the projector 100. The controller 420 creates an image signal of a sub-frame based on this base image signal. The base image signal is a so-called 4K2K image with 3840 (horizontal)×2160 (vertical) pixels, respectively. The number of pixels of this base image signal is four times larger than the number of pixels of the DMDs 240, 250, 260. This base image signal may be an image signal directly inputted from external equipment. Further, the base image signal may be a signal obtained by up-converting an input image with lower resolution inside the system. For example, the image with 1920 (horizontal)×1080 (vertical) pixels, respectively, inputted from the external equipment may be scaled to be twice larger each in the horizontal and vertical directions, to create a 4K2K image.

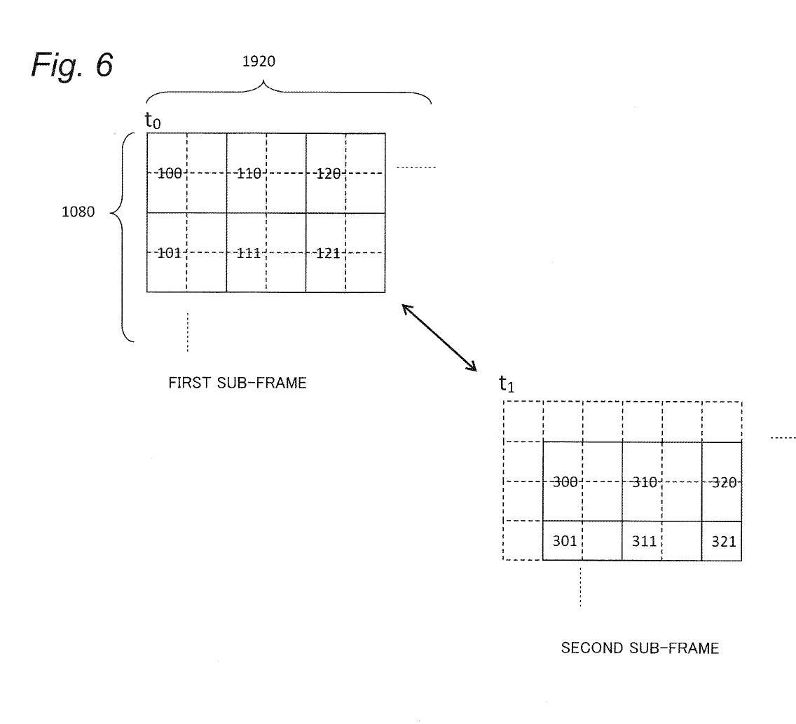

A method of creating a sub-frame signal in the image generator 410 is described below. FIG. 6 is a diagram explaining a method for creating two sub-frame signals from the base image signal in the high resolution mode. Each sub-frame signal is created as follows. It should be noted that each pixel composing the image is to be provided with a numerical value (starting from 0) having figures showing respective positions of the pixel in the horizontal and vertical directions.

### (1) First Sub-Frame Signal

This signal is generated by sampling, in the base image signal, a pixel having a figure showing a horizontal position has a remainder of 0 as divided by 2 and a figure showing a vertical position has a remainder of 0 as divided by 2.

### (2) Second Sub-Frame Signal

This signal is generated by sampling, in the base image signal, a pixel having a figure showing a horizontal position has a remainder of 1 as divided by 2 and a figure showing a vertical position has a remainder of 1 as divided by 2.

When the normal mode is selected, the second sub-frame is the same image as the first sub-frame.

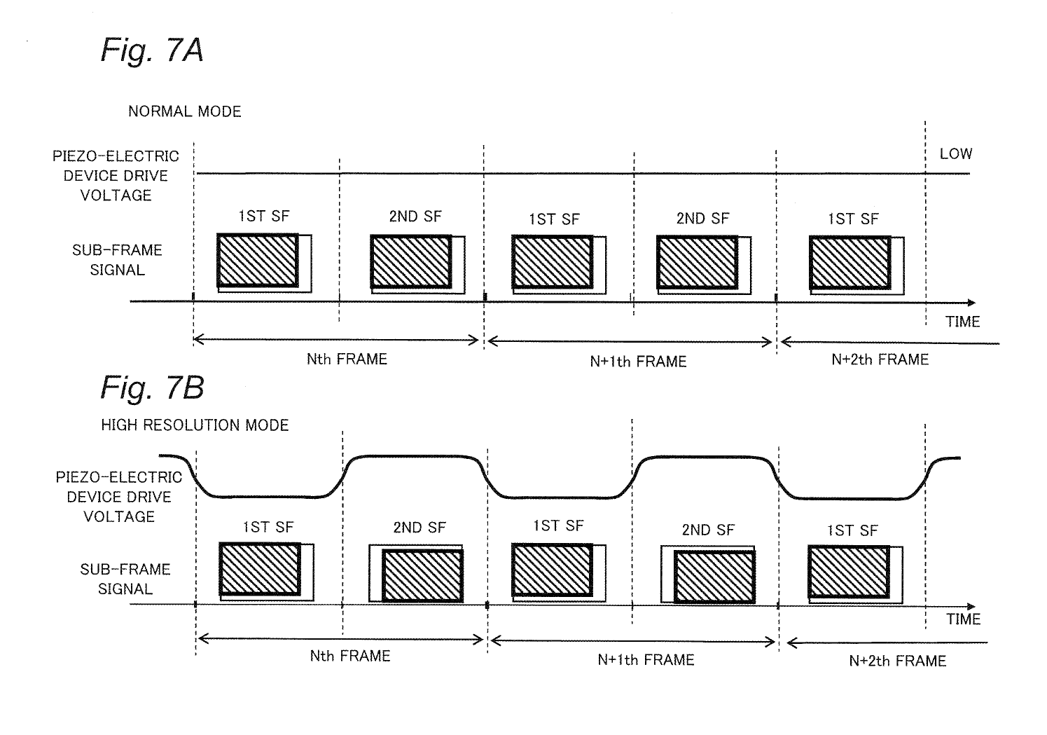

Next, with reference to FIG. 7, a relation between a sub-frame that is displayed in each of the DMDs 240 to 260 and drive (drive voltage) of the piezo-electric device is described below. FIG. 7A shows the case of the normal mode, and FIG. 7B shows the case of the high resolution mode. In the normal mode, as shown in FIG. 7A, a constant voltage (Low in the present example) is applied to the piezo-electric device 330 to keep the projected position a constant position. On the other hand, in the high resolution mode, as shown in FIG. 7B, a pulse voltage with a constant cycle is applied to the piezo-electric device 330, thereby to make switching between the projected positions of the image of the first sub-frame and the second sub-frame.

Each of the DMDs 240, 250, 260 outputs two sub-frames at twice a faster rate than a frame rate of an outputted image. For example, when the output frame rate is 30 Hz, the sub-frame is outputted at 60 Hz.

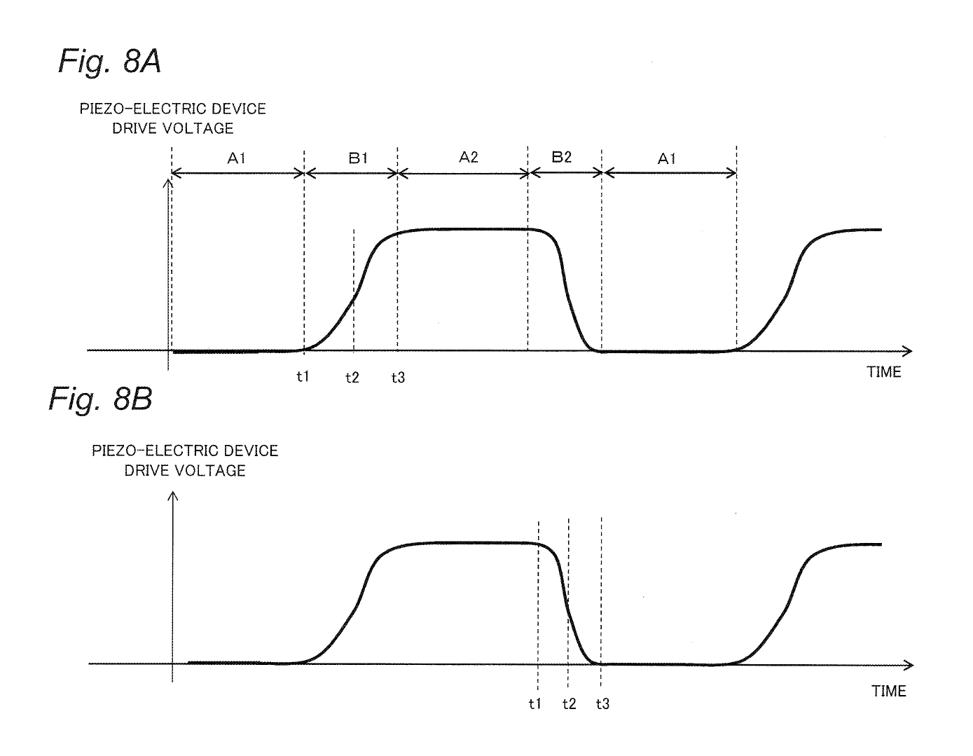

In the case of the high resolution mode, the piezo-electric device 330 is driven at 30 Hz. At this time, a waveform of the applied voltage to the piezo-electric device 330 has a constant voltage section and a voltage transition section, as shown in FIGS. 8A and 8B. Specifically, a first constant voltage section A1, a first voltage transition section B1, a second constant voltage section A2 and a second voltage transition section B2 constitute one cycle. In the case of drive at a frame rate of 30 Hz and each section has 8.3 msec, for example, the first constant voltage section A1 is set to 0 V and the second constant voltage section A2 is set to 150 V. A voltage waveform in the first voltage transition section B1 becomes a waveform smoothly connecting the two voltages with a voltage in the first constant voltage section A1 taken as a start voltage and a voltage in the second constant voltage section A2 taken as an end voltage.

In the case of FIG. 8, the voltage waveform in the first voltage transition section B1 is made up of part of a sine wave (a quarter cycle). The voltage waveform in the second voltage transition section B2 is made up of part of the sine wave (a quarter cycle), with the voltage of the second constant voltage section A2 taken as a start point and the voltage of the first constant voltage section A1 taken as an end point. The voltage waveform in the second voltage transition section B2 is made up of part of a sine wave with a shorter cycle than that of the sine wave constituting the voltage waveform of the first voltage transition section B1. That is, drive voltage waveforms of the piezo-electric device 330 are asymmetrical.

The drive voltage waveform of the piezo-electric device 330 may be configured to have a shape of a portion at which the constant voltage sections A1 or A2 is connected with the voltage transition sections B1 or B2, that is non-linear shape (waveforms which are connected not linearly but smoothly). That is, the drive voltage waveform of the piezo-electric device 330 is set not to have an abrupt change (i.e., waveform which does not change linearly but change smoothly). Setting the drive voltage waveform in such a manner can suppress abrupt shift (movement) of the piezo-electric device 330 to reduce drive sound more than in the case of applying a drive voltage with a rectangular shape (in the case of changing it linearly).

Further, as shown in FIGS. 8A and 8B, waveforms in a rising portion and a falling portion of the drive waveform are not symmetrical. This is described below.

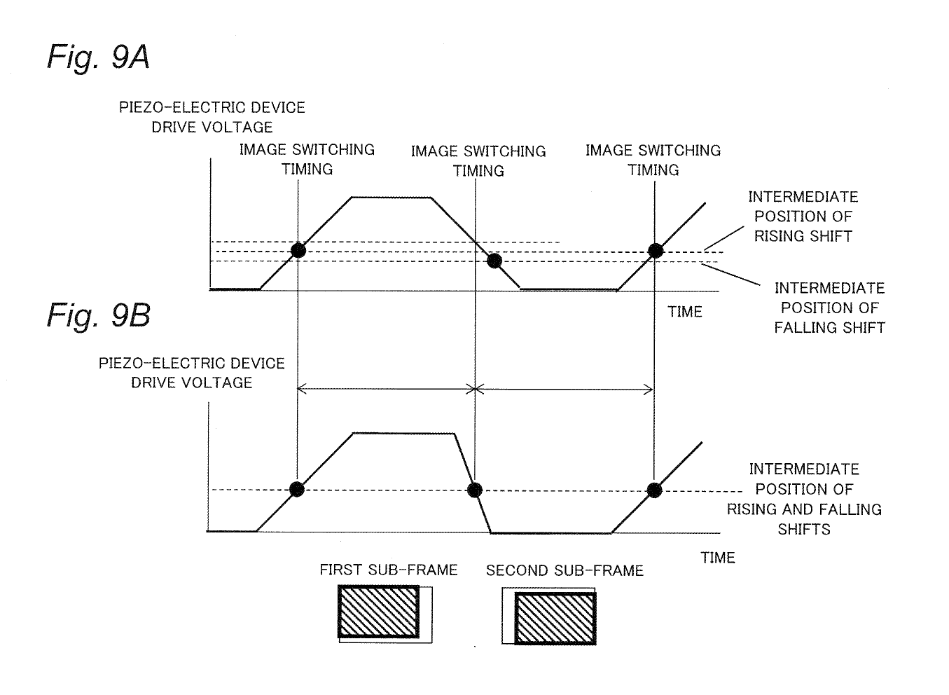

FIGS. 9A and 9B are graphs showing temporal changes in drive voltage of the piezo-electric device 330. A black circle in the figure shows timing at which the glass 320 as the optical device for changing an optical path of an image reaches an intermediate position between a position (hereinafter referred to as “first position”) corresponding to the first sub-frame and a position (hereinafter referred to as “second position”) corresponding to the second sub-frame.

The glass 320 as the optical device for changing an optical path of an image is shifted between the first position and the second position by pressing force (forward route) of the piezo-electric device 330 and restoring force (return route) of the spring. That is, in driving of the glass 320, the force applied to the glass 320 is different between the forward route (route from the first position to the second position) and the return route (route from the second position to the first position).

For this reason, as shown in FIG. 9A, in the case of driving the piezo-electric device 330 with a drive waveform where a rising waveform is symmetrical to a falling waveform, the timing for switching the images of the first sub-frame and the second sub-frame do not match a displace amount of the piezo-electric device 330 due to a difference between the pressing force (forward route) of the piezo-electric device 330 to the glass 320 and the restoring force (return route) of the spring, thus resulting in an image causing a large blur.

FIG. 9B is a diagram showing a drive waveform for making the image switch timing agree with an intermediate position of a displacement amount of the piezo-electric device 330, in consideration of hysteresis on the forward route and the return route. Specifically, the falling (return route) waveform is composed of a sine wave with a shorter cycle than a sine wave composing the rising (forward route) waveform. In the case of FIG. 9B, an image causing a small blur can be obtained as compared with the case of FIG. 9A. In such a manner, setting the rising drive waveform asymmetrical to the falling drive waveform can make an image with good image quality.

As described above, the projector 100 of the present embodiment applies a drive voltage having a waveform without an abrupt change to the piezo-electric device 330 that drives the optical device (glass 320) for shifting a projected optical path of an image, whereby it is possible to prevent abrupt shift of the glass 320 and the piezo-electric device 330 and suppress generation of noise.

### 2. Second Embodiment

### 2-1. Outline

The projector 100 of the present embodiment is provided with an optical device that can be shifted in two directions within a plane vertical to the optical axis of the projection optical system. The projector 100 shifts this optical device to displace projected positions on the screen of pixels composing an image generated by the DMD. Accordingly, the projector 100 can project a quadruple high resolution image.

### 2-2. Configuration

### 2-2-1. Configuration Between Prism and Projection Lens

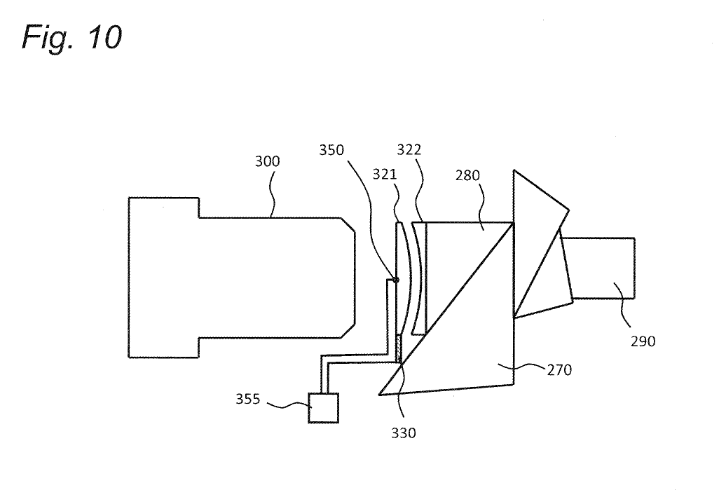

With reference to FIG. 10, an arrangement between the projection optical system 300 and a prism block including the total reflection prism and the color prism. FIG. 10 is a diagram for explaining an outline of the optical system provided between the projection optical system 300 and the prism block.

A lens 321 and a lens 322 are provided between the projection optical system 300 and the prism 280. The lens 322 is disposed on the prism block side. Further, the lens 321 is disposed on the projection optical system 300 side.

The lens 322 is a plano-concave lens configured to beflat on the prism 280 side and be a concave lens on the lens 321 side. The lens 321 is a plano-convex lens configured to be a convex lens on the lens 322 side and be flat on the projection optical system 300 side. The lens 321 is provided between the lens 322 and the projection optical system 300. A predetermined space is formed between the lens 321 and the lens 322. Further, a predetermined space is formed between the lens 321 and the projection optical system 300. Although FIG. 10 shows as if only the lens 321 is provided between the lens 322 and the projection optical system 300, the lens 321 is in practice provided with a lens outer frame 520 and the like which is described later. That is, a lens unit including the lens 321 is provided between the lens 322 and the projection optical system 300.

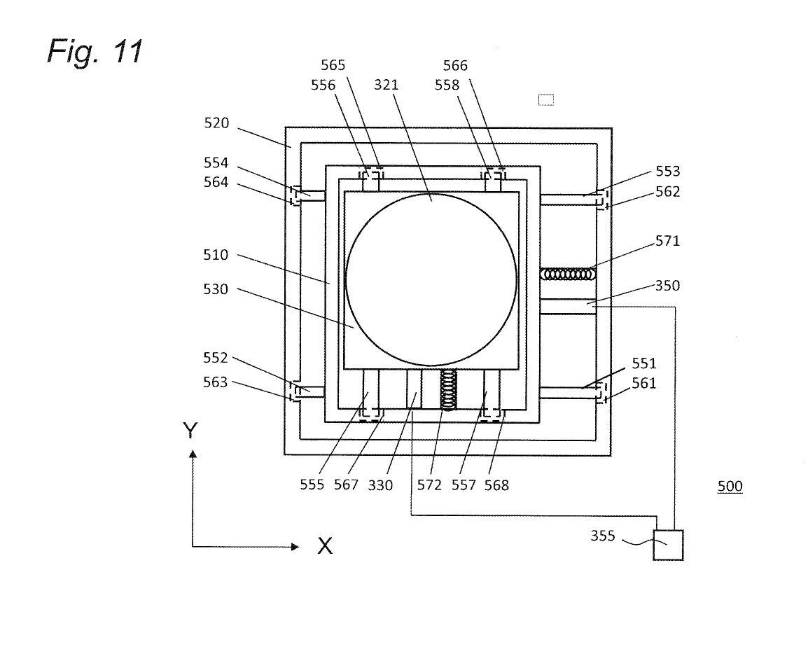

With reference to FIG. 11, a lens unit 500 including the lens 321 is described. FIG. 11 is a diagram for explaining a configuration of the lens unit 500 for realizing quadruple-density display.

The lens unit 500 has a lens inner frame 510, a lens outer frame 520 and a lens fixing member 530. The lens inner frame 510 is provided with supports 551, 552, 553, and 554. Moreover, the lens outer frame 520 is provided with reception holes 561, 562, 563, and 564. The support 551 is inserted in the reception hole 561. The support 552 is inserted in the reception hole 563. The support 553 is inserted in the reception hole 562. The support 554 is inserted in the reception hole 564. A sectional area of each reception hole is larger than a sectional area of each support. Therefore, the lens inner frame 510 is movably held with respect to the lens outer frame 520.

A piezo-electric device 350 that expands and shrinks in an X-direction is fixed to the lens outer frame 520. The piezo-electric device 350 is in contact only with the lens inner frame 510. The piezo-electric device 350 is connected with the signal generator 355. The signal generator 355 can separately apply voltages to the piezo-electric device 330 that extends in a Y-direction and the piezo-electric device 350 that extends in the X-direction. Upon application of the voltage from the signal generator 355, the piezo-electric device 350 extends. Both ends of a spring 571 are respectively fixed to the lens outer frame 520 and the lens inner frame 510. The spring 571 applies force to pull the lens inner frame 510 and the lens outer frame 520 close to each other. By the piezo-electric device 350 extending to press the lens inner frame 510, the lens inner frame 510 shifts (moves) in a minus X-axis direction with respect to the lens outer frame 520. Further, shrink of the piezo-electric device 350 and the spring 571 pulling the lens inner frame 510 causes the lens inner frame 510 to shift (move) in a plus X-axis direction with respect to the lens outer frame 520.

The lens fixing member 530 is provided with support rods 555, 556, 557, and 558. The lens inner frame 510 is provided with reception holes 565, 566, 567, and 568. The support rod 555 is inserted in the reception hole 567. The support rod 556 is inserted in the reception hole 565. The support rod 557 is inserted in the reception hole 568. The support rod 558 is inserted in the reception hole 566. A sectional area of each reception hole is larger than a sectional area of each support rod. Therefore, the lens fixing member 530 is movably held with respect to the lens inner frame 510.

The piezo-electric device 330 that extends in the Y-direction is fixed to the lens inner frame 510. The piezo-electric device 330 is in contact only with the lens fixing member 530. Also the piezo-electric device 330 is connected with the signal generator 355. The signal generator 355 can apply a voltage to the piezo-electric device 330. Upon application of the voltage from the signal generator 355, the piezo-electric device 330 extends in the Y-direction. Both ends of a spring 572 are respectively fixed to the lens inner frame 510 and the lens fixing member 530. The spring 572 applies force to pull the lens fixing member 530 and the lens inner frame 510 close to each other. Extension of the piezo-electric device 330 to press the lens fixing member 530 causes the lens fixing member 530 to shift in a plus Y-axis direction with respect to the lens inner frame 510. Further, shrink of the piezo-electric device 350 and the spring 572 pulling the lens fixing member 530 causes the lens fixing member 530 to shift in a minus Y-axis direction with respect to the lens inner frame 510.

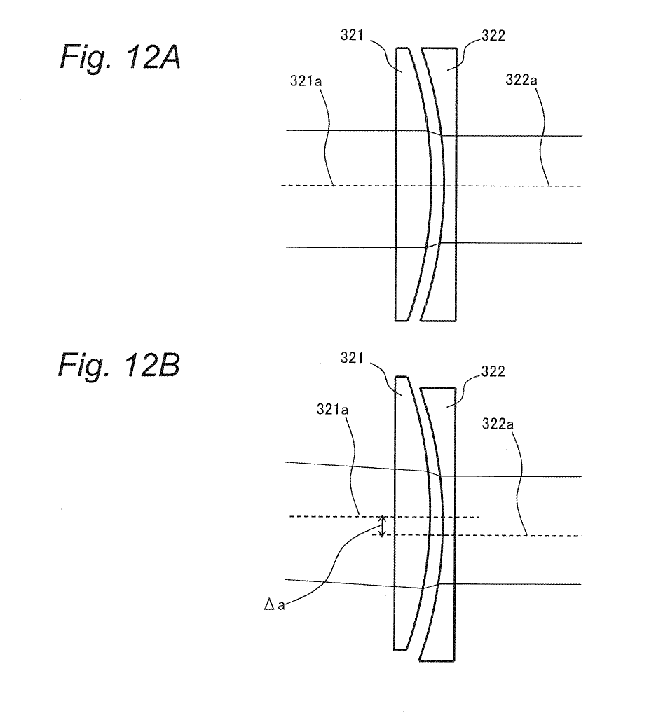

FIG. 12 is a diagram showing a positional relation between the fixed lens 322 and the lens 321 that shifts by shifting the lens inner frame 510 and the lens outer frame 520. As shown in the figure, the shift of the position of the lens 321 changes optical path of an image transmitted through the lens 321 and the lens 322.

As thus described, adjusting of a voltage to be applied to the piezo-electric device 330 that extends in the Y-direction and a voltage to be applied to the piezo-electric device 350 that extends in the X-direction allows the lens 321 to shift in a variety of directions within the plane vertical to the optical axis of the projection optical system 300.

### 2-3. Image Output Operation

### 2-3-1. System Configuration

In the second embodiment, the image generator 410 generates four sub-frame signals corresponding to shift of projected positions by the lens 321 and the piezo-electric devices 330, 350, for each frame of an inputted image signal.

The image generator 410 generates four sub-frame signals based on an inputted base image signal. The four sub-frame signals generated in the image generator 410 are transmitted to the display device driver 430 to generate a DMD drive signal for outputting an image at four times a faster rate than the output frame rate. The controller 420 generates a piezo-electric device drive signal to drive the piezo-electric devices 330, 350 in synchronization with the display device driver 430 to shift projected positions of pixels, and outputs the generated signal to the piezo-electric device driver 440.

### 2-3-2. Output Operation for Quadruple Resolution Image

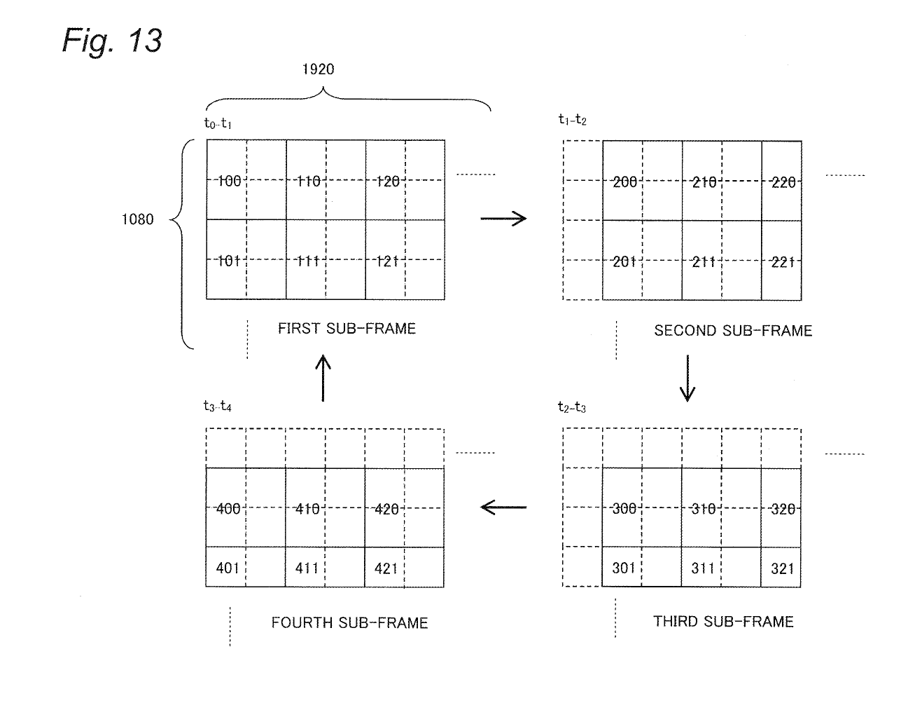

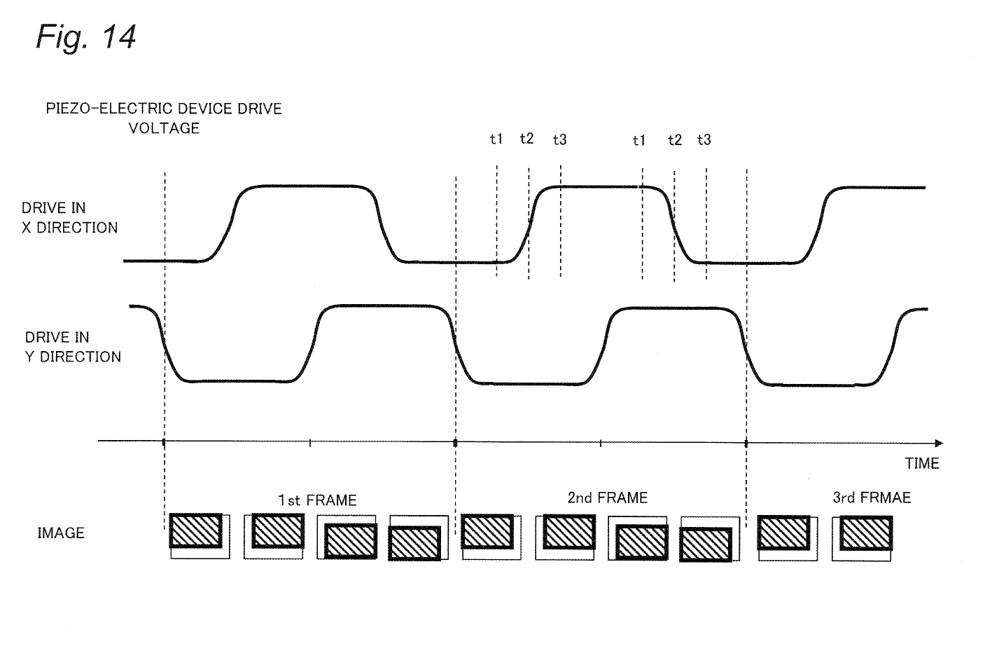

With reference to FIGS. 13 and 14, an operation of the image output system in a case where the projected position can be shifted in two directions is described. It is to be noted that the resolutions corresponding to the DMDs (display devices) 240, 250, 260 and the resolution of the base image signal are the same as in the first embodiment.

A method of creating a sub-frame signal in the image generator 410 of the present embodiment is described. FIG. 13 is a diagram explaining how the base image signal is sampled to create four sub-frame signals in the high resolution mode. Each sub-frame signal is created as follows.

### (1) First Sub-Frame Signal

This signal is generated by sampling, in the base image signal, a pixel having a figure showing a horizontal position has a remainder of 0 as divided by 2 and a figure showing a vertical position has a remainder of 0 as divided by 2.

### (2) Second Sub-Frame Signal

This signal is generated by sampling, in the base image signal, a pixel having a figure showing a horizontal position has a remainder of 1 as divided by 2 and a figure showing a vertical position has a remainder of 0 as divided by 2.

### (3) Third Sub-Frame Signal

This signal is generated by sampling, in the base image signal, a pixel having a figure showing a horizontal position has a remainder of 1 as divided by 2 and a figure showing a vertical position has a remainder of 1 as divided by 2.

### (4) Fourth Sub-Frame Signal

This signal is generated by sampling, in the base image signal, a pixel having a figure showing a horizontal position has a remainder of 0 as divided by 2 and a figure showing a vertical position has a remainder of 1 as divided by 2.

When the normal mode is selected, the first to fourth sub-frames are the same image.

With reference to FIG. 14, a relation between a sub-frame that is displayed in each of the DMDs (display devices) 240 to 260 and drive (drive voltage) of the piezo-electric device is described. Each of the DMDs 240 to 260 outputs four sub-frames at four times a faster rate than a frame rate of an output image. In synchronization with drive of the DMDs 240 to 260, each of the piezo-electric devices 330, 350 is driven at a rate being half of the frame rate of the output image. At this time, signals for driving the piezo-electric device 330 that gives a change in the Y-direction (vertical direction) and the piezo-electric device 350 that gives a change in the X-direction (horizontal direction) are inputted with wavelengths displaced by a quarter from each other.

When a drive voltage in a constant voltage section is applied to the one piezo-electric device 330, the other piezo-electric device 350 is extended. That is, when a drive voltage in the first constant voltage section is applied to the one piezo-electric device 330, a drive voltage that is applied to the other piezo-electric device 350 is in the first voltage transition section, changing from the first constant voltage to the second constant voltage. In this case, at the moment when the position of the projected pixel passes through a position which is a half of a pixel shift distance due to the change of the drive voltage of the piezo-electric device 350, switching is performed from the fourth sub-frame of the (N−1)-th frame to the first sub-frame of the N-th frame.

Next, when a drive voltage in the first constant voltage section is applied to the other piezo-electric device 350, a drive voltage in the first voltage transition section is applied to the one piezo-electric device 330, changing from the first constant voltage to the second constant voltage. In this case, at the moment when the position of the projected pixel passes through a position which is a half of a pixel shift distance due to the change of the drive voltage of the piezo-electric device 330, switching is performed from the first sub-frame to the second sub-frame. Subsequently, in the same manner, switching is performed from the second sub-frame to the third sub-frame, and from the third sub-frame to the fourth sub-frame.

As shown in FIG. 14, each transition section has three time points t1, t2, t3 in each of rising and falling time. Values of drive voltages at the respective time points t1, t2, t3 are denoted by v1, v2, v3. In the rising time, v1 is the first constant voltage and v3 is the second constant voltage. The voltage changes continuously from v1 to v3. Further, t2 is a time point that satisfies t1<t2<t3, and the voltage v2 at that time point satisfies v1<v2<v3. In the falling time, v1 is the second constant voltage and v3 is the first constant voltage, and hence the voltage changes continuously from v3 to v1 while v3>v2>v1 is satisfied.

As described above, also in the present embodiment, by changing the drive voltage without an abrupt change it is possible to prevent an abrupt variation of the piezo-electric device and reduce drive sound even at the time of displaying a quadruple-density image.

### 3. Third Embodiment

In the present embodiment, control of a drive voltage waveform for suppressing drive sound that is generated at the time of switching the projection mode is described. The projector 100 according to the present embodiment has the same configuration as in the foregoing embodiments. In the following description, in the high resolution mode, an image is to be displayed by use of the first and second sub-frames in one frame period. In the present example, a reference position of the piezo-electric device 330 (i.e., glass 320 as the optical device for changing an optical path) is a position (first position) of the piezo-electric device 330 at the time of projecting an image based on the first sub-frame. In the reference position, a move (shift) amount of the piezo-electric device 330 (i.e., glass 320 as the optical device for changing an optical path) is 0. In order to control the piezo-electric device 330 to the reference position, a Low voltage is applied to the piezo-electric device 330 as a drive voltage of the piezo-electric device. A state where the piezo-electric device 330, namely the glass 320 (optical device for changing an optical path), is in the reference position thereof is referred to as a “reference state”.

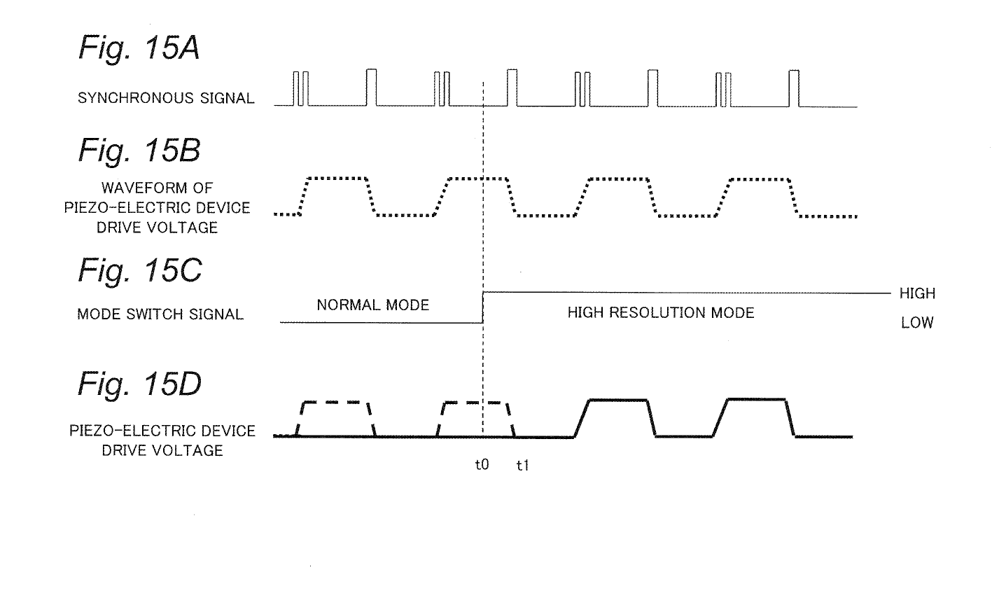

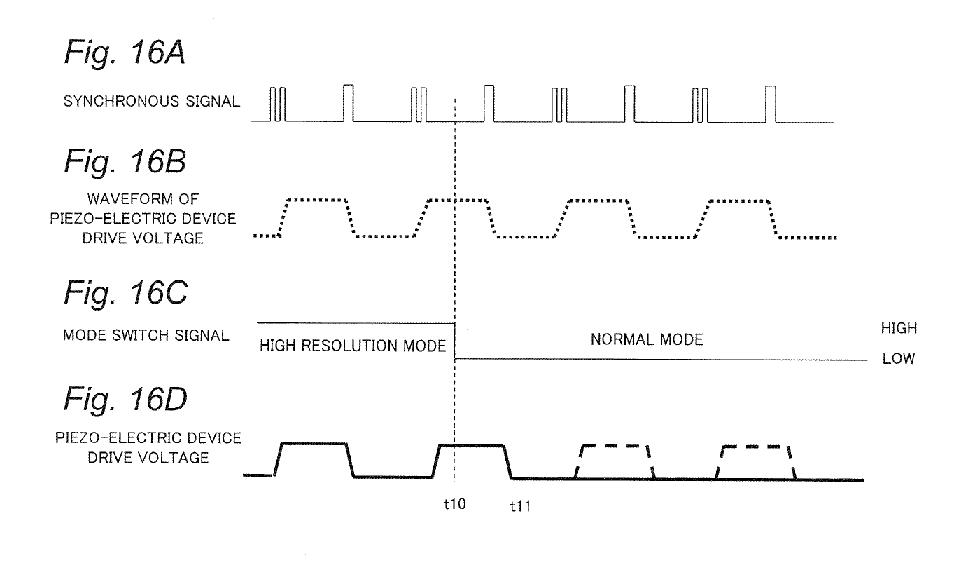

An operation of the piezo-electric device driver 440 in the projector 100 of the present embodiment is described with reference to FIGS. 15 and 16. FIG. 15 is a diagram explaining a drive voltage waveform of the piezo-electric device 330 by the piezo-electric device driver 440, and the like, in the case of switching from the normal mode to the high resolution mode. FIG. 16 is a diagram explaining a drive voltage waveform of the piezo-electric device 330, and the like, in the case of making switching from the high resolution mode to the normal mode.

Continuous two pulses in a synchronous signal shows start timing for either one of the first and second sub-frames, and a single pulse shows start timing for the other of the sub-frames.

First, with reference to FIG. 15, an operation of the piezo-electric device driver 440 in the case of switching from the normal mode to the high resolution mode.

The piezo-electric device driver 440 generates inside thereof a piezo-electric device drive waveform based on the synchronous signal, and applies, to the piezo-electric device 330, a piezo-electric device drive voltage generated based on the generated piezo-electric device drive waveform. When the high resolution mode is not selected (i.e., the mode switch signal is Low), the piezo-electric device driver 440 applies, to the piezo-electric device 330, a voltage (Low in the present example) to cause the position of the piezo-electric device 330 to be the reference position, as the piezo-electric device drive voltage, regardless of the generated piezo-electric device drive waveform.

Subsequently, when the high resolution mode is selected, namely when the mode switch signal is switched to High, the piezo-electric device driver 440 applies to the piezo-electric device 330 a drive voltage based on the piezo-electric device drive waveform. However, in this case, the piezo-electric device driver 440 does not immediately apply, to the piezo-electric device 330, the drive voltage based on the piezo-electric device drive waveform at the timing (t0) when the mode switch signal is switched to High. The piezo-electric device driver 440 starts application of the voltage based on the piezo-electric device drive waveform at timing (t1) when the position of the piezo-electric device 330 reaches the reference position (i.e., move amount of 0).

The same applies to the case where the high resolution mode is stopped, namely when switching is made from the high resolution mode to the normal mode. That is, as shown in FIG. 16, the piezo-electric device driver 440 does not immediately apply a voltage (Low) to control the piezo-electric device 330 to the reference position (i.e., does not stop output of the drive voltage based on the piezo-electric device drive waveform) at timing (t10) when the mode switch signal is received. The piezo-electric device driver 440 starts application of the Low voltage at timing (t11) when the position of the piezo-electric device 330 reaches the reference position (i.e., shift amount of 0) (i.e., stops output of the drive voltage based on the piezo-electric device drive waveform)

As described above, in the present embodiment, the mode is switched at a timing when the piezo-electric device 330, namely the glass 320 (optical device for changing an optical path), comes into the reference state in order to suppress an abrupt change in applied voltage to the piezo-electric device 330 at the time of switching the mode between the high resolution mode and the normal mode. Hence it is possible to suppress an abrupt variation in piezo-electric device 330, and suppress noise.

Although the shape of the drive voltage waveform of the piezo-electric device 330 has been described by means of a trapezoid in the present embodiment as shown in FIGS. 15 and 16, the drive voltage waveform may be a waveform that smoothly changes as shown in FIGS. 8 and 14 and the like of the first and second embodiments.

### 4. Fourth Embodiment

In the present embodiment, the piezo-electric device drive voltage is controlled such that after the mode is switched to the high resolution mode, the degree of shift of the projected position by the piezo-electric device 330 is gradually increased to control the projected position to a position with a desired displacement amount after the lapse of predetermined time. Additionally, the method of creating a second sub-frame is controlled in accordance with a change in projected position.

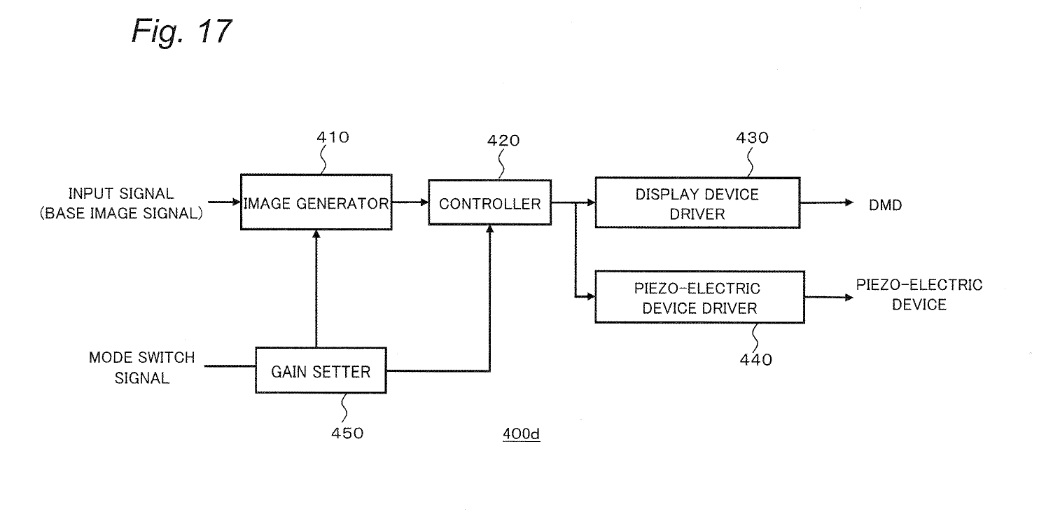

The projector 100 according to the present embodiment basically has the same configuration as in the foregoing embodiments. FIG. 17 is a diagram showing a configuration of an image output system 400d according to the present embodiment. The image output system 400d of the present embodiment has a gain setter 450 that sets a gain for an amplitude of the piezo-electric device drive waveform in addition to the configuration in the foregoing embodiments. When receiving the mode switch signal, the gain setter 450 sets a gain for the amplitude of the piezo-electric device drive waveform based on the elapsed time from receipt of the mode switch signal. In the high resolution mode, the image generator 410 generates two sub-frame signals based on the set gain and the base image signal. The piezo-electric device driver 440 generates a piezo-electric device drive waveform based on a synchronous signal outputted from the controller 420, and applies to the piezo-electric device 330 a drive voltage obtained by multiplying the drive waveform by the gain.

The gain setter 450 receives the mode switch signal inputted into the system, and measures the time after switching of the mode. The gain setter 450 generates, based on the counted elapsed time, a gain having a value between 0 and 1, by which the piezo-electric device drive waveform is to be multiplied. When the projection mode is switched from the normal mode to the high resolution mode, the gain is increased in accordance with the elapsed time. On the other hand, when it is switched from the high resolution mode to the normal mode, the gain is reduced in accordance with the elapsed time.

It is to be noted that the degree (amount) of change in the gain may be changed monotonically according to the elapsed time, and a value obtained by performing constant multiplication of the lapsed time is taken as an amount of change. Further, the amount of change may be non-linearly changed according to the elapsed time. In this case, since the changing time for the observed image is short, it is possible to reduce discomfort that an observer feels at the time when the mode is switched. Further, an amount of change in gain may be changed in accordance with the display mode of the system. For example, in an image quality priority mode, the amount of change in gain may be increased. This leads to quick switching between the high resolution mode and the normal mode, thereby allowing reduction in unnatural display.

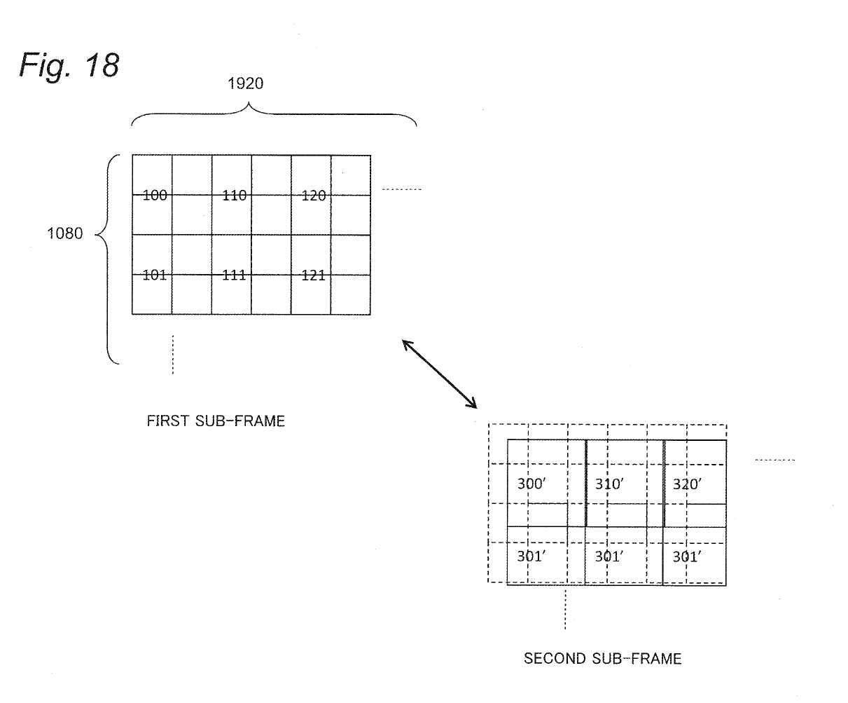

With reference to FIG. 18, a method of creating a sub-frame signal by the image generator 410 at the time of outputting a double-density image is described. FIG. 18 shows a sampling method in the case of setting the gain to 0.5. When the gain is 0.5, it means that shift of the projected position is a half of a normal shift amount.

That is, it is necessary in the base image signal to sample each pixel of the second sub-frame in an intermediate position between obliquely adjacent pixels. Hence the first sub-frame and the second sub-frame are sampled by the same method as in the first embodiment. Subsequently, a value obtained by weighted average of pixel values of pixels located in the same positions on the first and second sub-frame at a ratio of 1:1, is taken as a final pixel value of the second sub-frame. That is, the final pixel value (P′) of the second sub-frame is calculated by the following formula (1).

P′[300]=(1−α)P[100]+αP[300] (1)

Here, P[100] is a pixel value of the first sub-frame, and P[300] is an initially calculated pixel value of the second sub-frame. A weight α is a gain of 0.5. Thereby, the pixel value of the second sub-frame is a pixel value corresponding to the shift amount of the projected position. Similarly, when a gain is 0.25, a value obtained by weighted average of pixels located on the same position on the sub-frames at 1:3 is a pixel value of the second sub-frame.

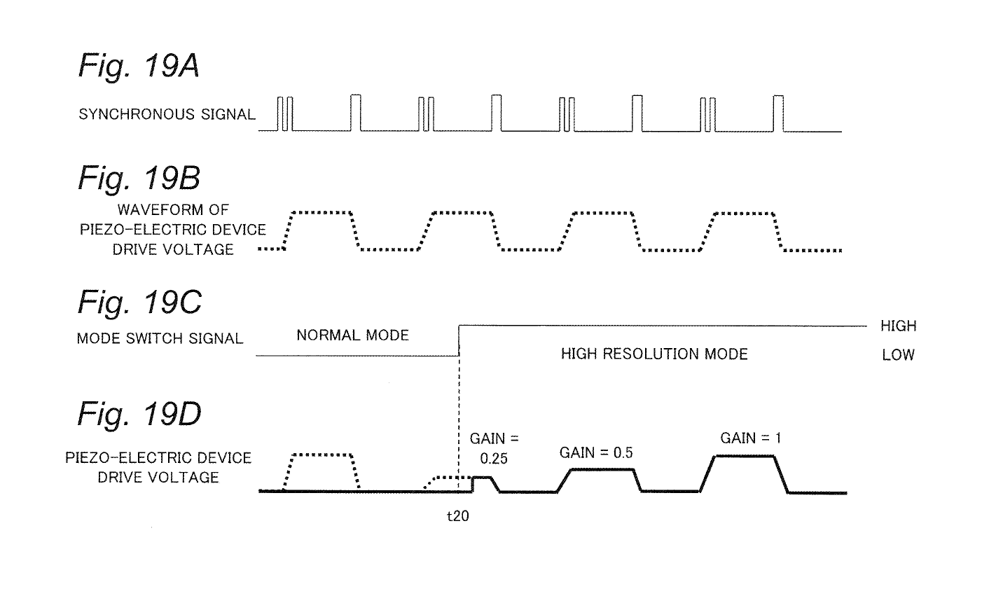

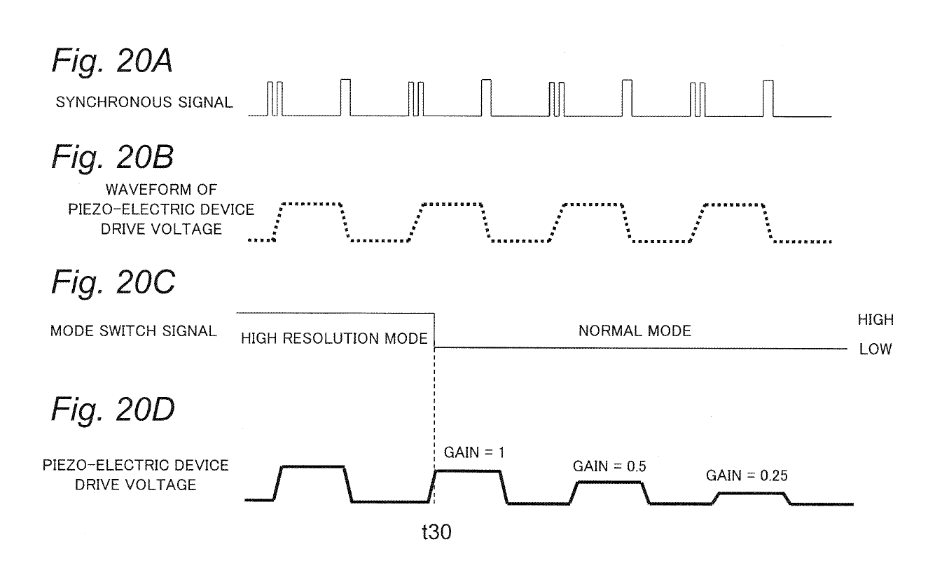

With reference to FIGS. 19 and 20, an operation of the piezo-electric device driver 440 of the present embodiment is described. FIG. 19 is a diagram explaining a waveform of a drive voltage that is applied to the piezo-electric device 330 by the piezo-electric device driver 440, and the like, in the case of switching from the normal mode to the high resolution mode. FIG. 20 is a diagram explaining an applied voltage waveform, and the like, in the case of switching from the high resolution mode to the normal mode. The piezo-electric device driver 440 generates a piezo-electric device drive waveform based on a synchronous signal, and applies to the piezo-electric device 330 a drive voltage obtained by multiplying the waveform by the gain.

For example, in the example of FIG. 19, although the mode is switched from the normal mode to the high resolution mode at timing t20, in the frame where the mode switching occurs, a voltage obtained by multiplying the piezo-electric device drive waveform by a gain of 0.25 is applied as the drive voltage to the piezo-electric device 330 at the moment of switching to the high resolution mode. Then in the next frame, a voltage obtained by multiplying the piezo-electric device drive waveform by a gain of 0.5 is applied as the drive voltage to the piezo-electric device 330. By gradually increasing the gain in such a manner, the value of the drive voltage that is applied to the piezo-electric device 330 is gradually increased.

Further, in the example of FIG. 20, although the mode is switched from the high resolution mode to the normal mode at timing t30, in the frame where the mode switching occurs, a voltage obtained by multiplying the piezo-electric device drive waveform by a gain of 1 is applied as the drive voltage to the piezo-electric device 330 at the moment of switching to the normal mode. Then in the next frame, a voltage obtained by multiplying the piezo-electric device drive waveform by a gain of 0.5 is applied as the drive voltage to the piezo-electric device 330. In still the next frame, a voltage obtained by multiplying the piezo-electric device drive waveform by a gain of 0.25 is applied as the drive voltage to the piezo-electric device 330. By gradually decreasing the gain in such a manner, the value of the drive voltage that is applied to the piezo-electric device 330 is gradually decreased.

In the present embodiment, in order to suppress an abrupt change in applied voltage to the piezo-electric device 330 at the time of switching between the high resolution mode and the normal mode by means of the mode switch signal, the amplitude of the drive voltage of the piezo-electric device 330 is suppressed so as to suppress a voltage change from the reference state for a predetermined period after the switching. This can suppress noise of the piezo-electric device 330 which is generated at the time of switching the mode.

Although the shape of the drive voltage waveform of the piezo-electric device 330 has been described by means of a trapezoid in the present embodiment as shown in FIGS. 19 and 20, the drive voltage waveform may be a waveform that smoothly changes as shown in FIGS. 8 and 14 and the like, as shown in the first and second embodiments. Further, as for control concerning the drive voltage waveform of the piezo-electric device, the idea disclosed in the third embodiment is applicable to the present embodiment.

### 5. Other Embodiments

Although the mode switch signal has been described as the signal generated inside the projector 100 in the above embodiments, it may be a signal inputted from the outside.

The first embodiment and the like, described the example of creating the state of being shifted by a half pixel in both the horizontal direction and the vertical direction by drive of the glass 320 and the piezo-electric device 330. But the shift of pixel position is not restricted to this. The shift may be made in only either the horizontal direction or the vertical direction, and a shift amount may be not larger than a half pixel.

Although the DMD has been used as the display device in the above embodiments, the display device is not limited to this. Another display device such as a liquid crystal display can be used as the display device in place of the DMD.

Although the piezo-electric device has been used as the device to shift the optical device in the above embodiments, the device to shift the optical device is not restricted to this. A VCM (Voice Coil Motor) may be used in place of the piezo-electric device.

Although it has been described in the above embodiment that the shape of the waveform of the drive voltage of the piezo-electric device 330 in the voltage transition section is the shape of part of the sine wave (shape of a quarter cycle), the shape of the waveform in the voltage transition section is not restricted thereto. For example, the waveform of the drive voltage may be a waveform having a shape that is formed by parts of an arc (a quarter circle) reversely connected. That is, the waveform of the drive voltage may be a waveform not to have an abrupt change. In other words, the waveform of the drive voltage of the piezo-electric device 330 in the voltage transition section may be set to a waveform of which differentiated waveform is a continuous waveform.

The functions of the image generator 410, the controller 420, the display device driver 430, the piezo-electric device driver 440 and the gain setting unit 450 shown in the above embodiments are realized by a CPU or a MPU executing a predetermined program. Alternatively, those functions can also be realized by an electronic circuit dedicatedly designed for realizing dedicated functions.

### 6. Summary of Present Disclosure

The above embodiments disclose the projector 100 (one example of the projection display apparatus) having the following configuration.

The projector 100 includes: the DMD (one example of the image display unit) 240 to 260 configured to display an image; the projection optical system 300 configured to project the image on the screen (projection plane); the optical path changing unit (glass 320, lens 321, as one example) which is disposed in the space between the DMD 240 to 260 and the screen configured to change an optical path of the image to change projected positions, on the screen, of at least part of pixels composing the image generated by the DMD 240 to 260; the piezo-electric device 330 configured to shift the optical path changing unit 320, 321; and the image output system 400 and 400d (one example of the drive controller) configured to control the piezo-electric device 330.

The image output system (400, 400d) controls the piezo-electric device 330 with the first constant voltage in the first constant voltage section A1, and controls the piezo-electric device 330 with the second constant voltage that is larger than the first constant voltage in the second constant voltage section A2. The image output system (400, 400d) controls the piezo-electric device 330 with the first transition voltage that continuously changes from the first constant voltage to the second constant voltage in the first transition section (B1) between the first constant voltage section (A1) and the second constant voltage section (A2). The first transition voltage is a voltage that a waveform obtained by differentiating the first transition voltage is a continuous waveform.

With the above configuration, the drive voltage of the piezo-electric device 330 is changed without an abrupt change, whereby it is possible to suppress an abrupt variation in piezo-electric device 330 and noise.

Further, the image output system (400, 400d) may have the second transition section (B2) between the second constant voltage section (A2) and the first constant voltage section (A1), in which the driver is controlled with the second transition voltage that continuously changes from the second constant voltage to the first constant voltage. The second transition voltage is a voltage that a waveform obtained by differentiating the second transition voltage is a continuous waveform.

The waveform of the first transition voltage may be asymmetrical to the waveform of the second transition voltage (cf. FIG. 8, etc.).

The first and second transition voltages may include the waveform of part of a sine wave.

The image output system (400, 400d) may have, as a projection mode, the normal mode (first mode) for projecting the image on the projection plane without shifting the optical path changing unit, and the high resolution mode (second mode) for projecting the image on the projection plane while shifting the optical path changing unit, to display an image with higher resolution than the normal mode.

Upon receipt of the instruction to switch the projection mode from the normal mode to the high resolution mode, the image output system (400) may start shifting the piezo-electric device (i.e., glass 320) at timing when the shift amount of the optical path changing unit is 0.

Upon receipt of the instruction to switch the projection mode from the normal mode to the high resolution mode, the image output system (400d) may increase the amplitude of shift of the optical path changing unit stepwise until the amplitude value becomes a predetermined one in accordance with elapsed time from start of shift of the optical path changing unit.

Upon receipt of the instruction to switch the projection mode from the high resolution mode to the normal mode, the image output system (400) may stop shifting the optical path changing unit 320, 321 at timing when the shift amount of the optical path changing unit is 0.

Upon receipt of then instruction to switch the projection mode from the high resolution mode to the normal mode, the image output system (400d) may decrease the amplitude of shift of the optical path changing unit stepwise in accordance with elapsed time from receipt of the instruction.

As thus described, the embodiment considered as the best mode and the other embodiments have been provided by means of the attached drawings and the detailed descriptions. These are to be provided to the skilled person in the art for illustrating the subject recited in the claims by referring to a specific embodiment. Accordingly, the foregoing embodiments can be subjected to modification, replacement, addition, omission and the like in the claims and an equivalent range thereto.

### INDUSTRIAL APPLICABILITY

The present disclosure can be applied to a projection display apparatus such as a projector.

What is claimed is:

1. A projection display apparatus comprising:
a display unit configured to display an image;
an optical system configured to project the image displayed by the display unit on a projection plane;
an optical path changing unit configured to change an optical path of the image to change projected positions, on the projection plane, of at least part of pixels composing the image displayed by the display unit, the optical path changing unit disposed in a space between the display unit and the projection plane;
a driver configured to shift the optical path changing unit; and
a drive controller configured to control the driver,
wherein
the drive controller controls the driver with a first constant voltage in a first constant voltage section, controls the driver with a second constant voltage that is larger than the first constant voltage in a second constant voltage section, and controls the driver with a first transition voltage that continuously changes from the first constant voltage to the second constant voltage in a first transition section between the first constant voltage section and the second constant voltage section, and
the first transition voltage is a voltage that a waveform obtained by differentiating the first transition voltage is a continuous waveform.

2. The projection display apparatus according to claim 1, wherein
the drive controller has a second transition section between the second constant voltage section and the first constant voltage section, in which the driver is controlled with a second transition voltage that continuously changes from the second constant voltage to the first constant voltage, and
the second transition voltage is a voltage that a waveform obtained by differentiating the second transition voltage is a continuous waveform.

3. The projection display apparatus according to claim 2, wherein the waveform of the first transition voltage is asymmetrical to the waveform of the second transition voltage.

4. The projection display apparatus according to claim 1, wherein the first transition voltage includes the waveform of part of a sine wave.

5. The projection display apparatus according to claim 2, wherein the second transition voltage includes the waveform of part of a sine wave.

6. The projection video display device according to claim 1, wherein
the drive controller has, as a projection mode, a first mode for projecting the image on the projection plane without shifting the optical path changing unit, and a second mode for projecting the image on the projection plane while shifting the optical path changing unit to display an image with higher resolution than the first mode.

7. The projection display apparatus according to claim 6, wherein, upon receipt of an instruction to switch the projection mode from the first mode to the second mode, the drive controller starts shifting the optical path changing unit at timing when a shift amount of the optical path changing unit is 0.

8. The projection display apparatus according to claim 6, wherein, upon receipt of an instruction to switch the projection mode from the first mode to the second mode, the drive controller increases an amplitude of shift of the optical path changing unit stepwise until an amplitude value becomes a predetermined value in accordance with elapsed time from start of shift of the optical path changing unit.

9. The projection display apparatus according to claim 6, wherein, upon receipt of an instruction to switch the projection mode from the second mode to the first mode, the drive controller stops shifting the optical path changing unit at timing when a shift amount of the optical path changing unit is 0.

10. The projection display apparatus according to claim 6, wherein, upon receipt of an instruction to switch the projection mode from the second mode to the first mode, the drive controller decreases an amplitude of shift of the optical path changing unit stepwise in accordance with elapsed time from receipt of the instruction.
